(19) United States
(12) Patent Application Publication
(10) Pub. No.: US 2018/0210749 A1
(43) Pub. Date: Jul. 26, 2018

(54) LOAD GENERATOR WITH A TOKEN MACHINE

(71) Applicant: HEWLETT PACKARD ENTERPRISE DEVELOPMENT LP, Houston, TX (US)

(72) Inventors: Shaul Strachan, Yehud (IL); Alexander Vainshtein, Ramat-Gan (IL); Tobias Grunzweig, Ra'ananna (IL)

(73) Assignee: HEWLETT PACKARD ENTERPRISE DEVELOPMENT LP, Houston, TX (US)

(21) Appl. No.: 15/578,395

(22) PCT Filed: Jul. 23, 2015
(86) PCT No.: PCT/US15/41668

§ 371 Date: Nov. 30, 2017

(51) Int. Cl. G06F 9/455; H04L 29/06; G06F 17/30

(52) U.S. Cl. CPC G06F 9/45558; G06F 17/30864; H04L 63/08

(57) ABSTRACT

In example implementations, an apparatus is provided. The apparatus includes a plurality of tokens, a plurality of states and an interface to a scheduler. Each one of the states represents a state of a state machine that is an abstraction of a business logic. Each one of the plurality of tokens is located at one of the plurality of states. A schedule of transitions for moving the plurality of tokens between two states of the plurality of states is received by the interface to the scheduler. The plurality of tokens is controlled in accordance with the schedule of transitions with a single call.

### BACKGROUND

Load testing or performance testing the complex systems may involve testing routine flows with multiple flow executions. Typically, testing the routine flows may involve different code with its own errors for each one of the routine flows. In addition, multiple different state machines associated with the complex systems are tracked individually for each user to simulate loads on the complex systems.

### BRIEF DESCRIPTION OF THE DRAWINGS

FIG. 1 is a block diagram of an example load generator node of the present disclosure

FIG. 2 is a block diagram of an example system of the present disclosure with the example load generator node;

FIG. 3 is a block diagram of an example controller of the present disclosure;

FIG. 4 is a block diagram of the example controller and a table of observations;

FIG. 5 is a flowchart of an example method for simulating a load generated on a system using a token machine; and

FIG. 6 is a high-level block diagram of an example computer suitable for use in performing the functions described herein.

### DETAILED DESCRIPTION

The present disclosure discloses a method, system and apparatus for simulating a load generated on a system using a token machine. Testing complex systems implemented by programmers is a long and laborious process. As discussed above, testing the complex systems may involve testing routine flows with multiple flow executions. Typically, testing the routine flows may involve different code with its own errors for each one of the routine flows. In addition, multiple different state machines associated with the complex systems are tracked individually for each user to simulate loads on the complex systems.

For example, a state machine has one active state, which shifts as transitions occur following certain inputs associated with them. Since a state machine handles a single instance, in order to support multiple instances a system would have to be composed of multiple instances of state machines. This would still leave the need to manage the different state machines, synchronize them, control them, read the states of the different state machines, and so on.

Examples of the present disclosure provide a simulation of a load generated on a system using a token machine. For example, instead of managing multiple instances of a number of users on multiple instances of the state machine, all of the users are managed in a single state machine represented by tokens in the token machine. In addition, there are no active or inactive states. Rather, each token representing a virtual user is moved from one state to another when a transition occurs in accordance with a schedule.

As a result, the present solution is easily scalable for any number of users required to simulate a load generated on a system (e.g., a website). In addition, the response of each token during each transition and which state the tokens are located in may be easily recorded to understand the system.

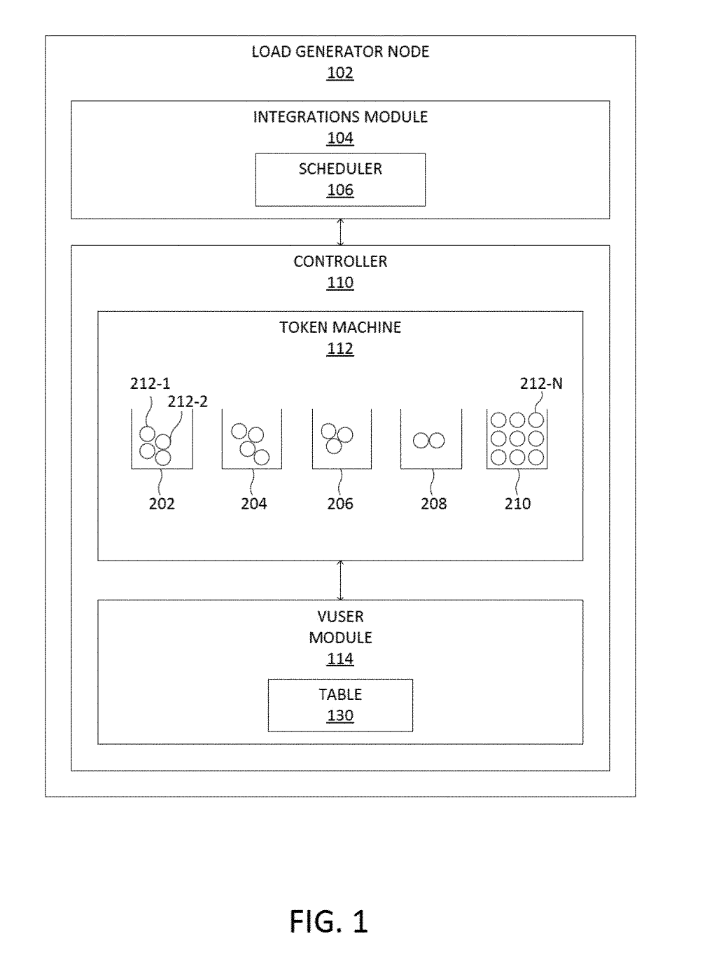

FIG. 1 illustrates an example load generator (LG) node 102 of the present disclosure. The LG node 102 may include an integrations module 104 and a controller 110. In one example, the integrations module 104 may include a scheduler 106.

In one example, the controller 110 includes a token machine 112 and a virtual user (VUSER) module 114. In one example, the token machine 112 may include a plurality of states 202, 204, 206, 208 and 210 represented as bins holding tokens 212-1 to 212-N (herein referred to individually as token 212 or collectively as tokens 212). Each one of the plurality of tokens 212 may represent a virtual user. The state machine may include a plurality of different states that represents an abstraction of a system. In one example, the system may be a business logic (e.g., a website) that has a particular structure or logic in the actions a user may initiate and responses to those actions in the business logic. For example, when the system is a website the website may have links. When the links are clicked the website may respond by redirecting the user to another website or web page within the website.

In one example, the VUSER module 114 may include a table 130. The table 130 may track an observation of the movement and transitions for each one of the tokens 212. For example, the table 130 may record the movement and transitions of each one of the tokens 212 that represents a virtual user.

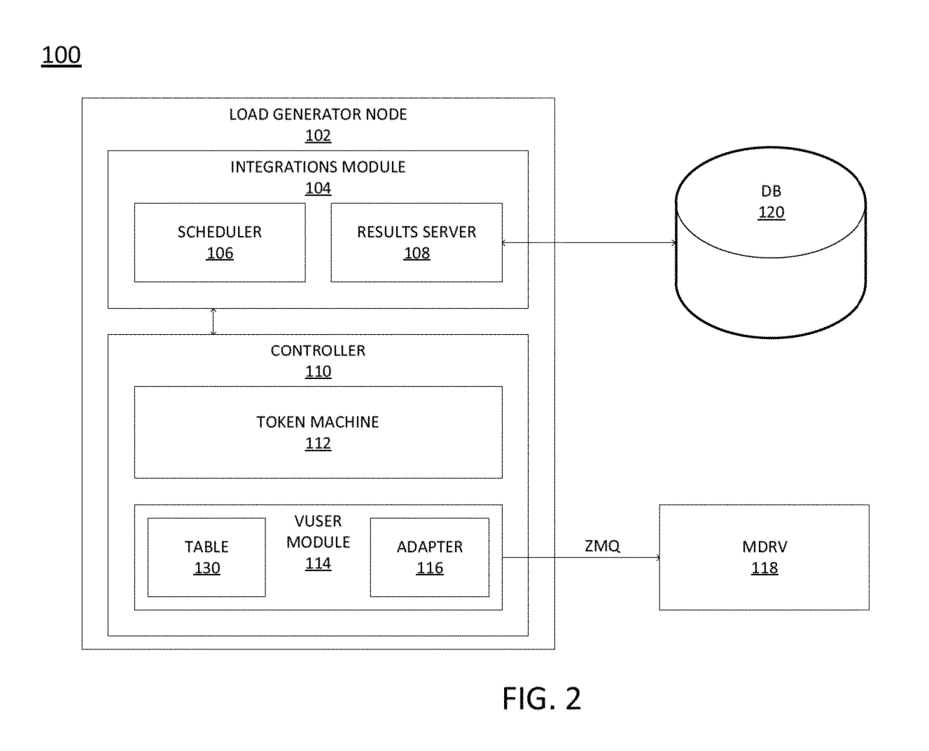

FIG. 2 illustrates an example system 100 of the present disclosure having the LG node 102. In one example, the integrations module 104 of the LG node 102 may include a results server 108. In one example, the results server 108 of the integrations module 104 may be in communications with a database (DB) 120. In one example, the DB 120 may be part of the LG node 102 or may be located remotely from the LG node 102.

In one example, the controller 110 may include an adapter 116. The adapter 116 may be used to communicate with a multi-threaded driver processor (MDRV) 118 using a zero MQ (ZMQ) high performance messaging library.

As noted above in FIG. 1, the token machine 112 may include a plurality of tokens 212 and a plurality of states 202-210 of a state machine. Each one of the plurality of tokens 212 may represent a virtual user. The state machine may include a plurality of different states 202-210 that represents an abstraction of a system.

In one example, the different states 202-210 may include down, ready, running, error and finished that abstracts a particular action and response of the business logic. The token machine 112 may include which business logic is being tested. The simulation of the business logic and the system is controlled by the MDRV 118. For example, the MDRV 118 controls the movement of each one of the plurality of tokens 212 within the token machine 112.

In one example, a transition may connect two of the states 202-210. For example, an initializing transition may connect a down state and a ready state, a starting transition may connect a ready state and a running state, and a stopping transition may connect a running state and a finished state. The transition between states in the state machine may be bound to logic in the MDRV 118. Each one of the plurality of tokens 212 may be initialized to start in one of the states 202-210 of the token machine 112.

In one example, the scheduler 106 may generate a schedule that is used by the controller 110 to execute movement of the tokens 212 from one state to another state. In one example, the schedule may be a pre-defined script written by a performance engineer to impersonate virtual users on the system, and thus, simulate a generated load on the system that is being tested. The schedule may define how each token 212 is to move with the token machine 112 and how long each token 212 is supposed to stay in a particular state 202-210. For example, in a retail website the schedule may define that a token 212 is to “log in,” “browse,” “perform a search,” “place an order,” and “log out.”

In one example, the schedule may call the token machine 112 for each segment of the schedule. The token machine 112 may then instruct the MDRV 118 to run a particular portion of a script in accordance with the schedule for each virtual user represented by a token 212 in the token machine 112. The MDRV 118 causes the particular portion of the script to run in the token machine 112.

Notably, a single call by the controller 112 may be used to simultaneously move all of the tokens 212 in accordance with the schedule generated by the scheduler 106. In other words, unlike current methods that require an engineer to monitor and test a plurality of different state machines for each virtual user, the present disclosure automatically simulates a load generated by any number of virtual users.

For example, in previous methods if an engineer wanted to simulate 100 virtual users on a state machine of a website, the engineer would manage and monitor 100 different state machines. In addition, the engineer would manually move each one of the 100 virtual users from one state to another state in each one of the 100 state machines. In contrast, the present disclosure enables a single call to a single schedule that executes the movement and transitions of all 100 virtual users via the use of tokens 212 in the token machine 112.

In addition, unlike current methods, the movement of each user from state to state does not occur manually. Rather, the present disclosure automatically simulates movements and transitions for each virtual user represented by one of the tokens 212-1 to 212-N using a single state machine in the token machine 112.

The results or observed behavior for each virtual user on a particular state may be recorded in the table 130 and may be fed to the results server 108 and stored in the DB 120. In one example, the adapter 116 may format the results of each virtual user represented by a token 212-1 to 212-N and transmit them to the MDRV 118 for processing.

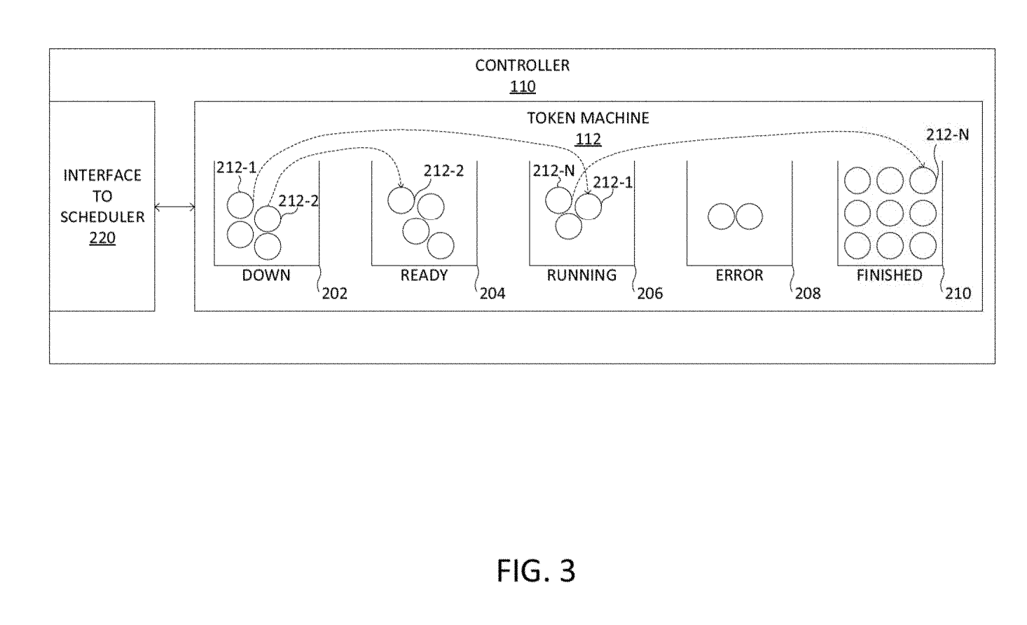

FIG. 3 illustrates a more detailed block diagram of the example controller 110. In one example, the controller may be deployed as a processor that controls the token machine 112 in accordance with a schedule of transitions received from the scheduler 106 via an interface 220 to the scheduler 106.

In one example, the token machine 112 may be built using computer executable code in JavaScript. The token machine 112 may include a plurality of states 202, 204, 206, 208 and 210 of a state machine. For example, the state 202 may be a down state, the state 204 may be a ready state, the state 206 may be a running state, the state 208 may be an error state and the state 210 may be a finished state. It should be noted that the states 202-210 are only provided as examples and the token machine 112 may include any type of states and any number of states.

In one example, the states 202-210 may be represented as buckets or bins holding tokens 212-1 to 212-N. In one example, a number of the tokens 212 may be a function of a desired number of virtual users for simulating a generated load on the system (e.g., a website). In one example, the tokens 212 may be built as objects within the token machine 112 using computer executable code in JavaScript.

It should be noted that the token machine 112 does not have any active or inactive states. For example, in a traditional state machine for a single virtual user, the virtual user is represented based on which state in the state machine is active or inactive. In contrast, the token machine 112 represents each virtual user with a token 212 and includes all of the states 202-210 of a state machine. Rather than indicating which states 202-210 are active or inactive, a state (e.g., 202 for token 212-1) is “active” for a virtual user when a corresponding token 212 is located in the state (e.g., token 212-1 located at state 202 indicates that state 202 is active for the virtual user represented by the token 212-1).

Notably, the token machine 112 provides the ability to simulate a plurality of different virtual users on a single state machine. For example, the tokens 212 allow for simultaneous movement and transitions in a single state machine in the token machine 112. In addition, the use of the token machine 112 and the tokens 212 allow for simultaneously moving each one of the tokens 212 using a single call based on the schedule generated by the scheduler 106.

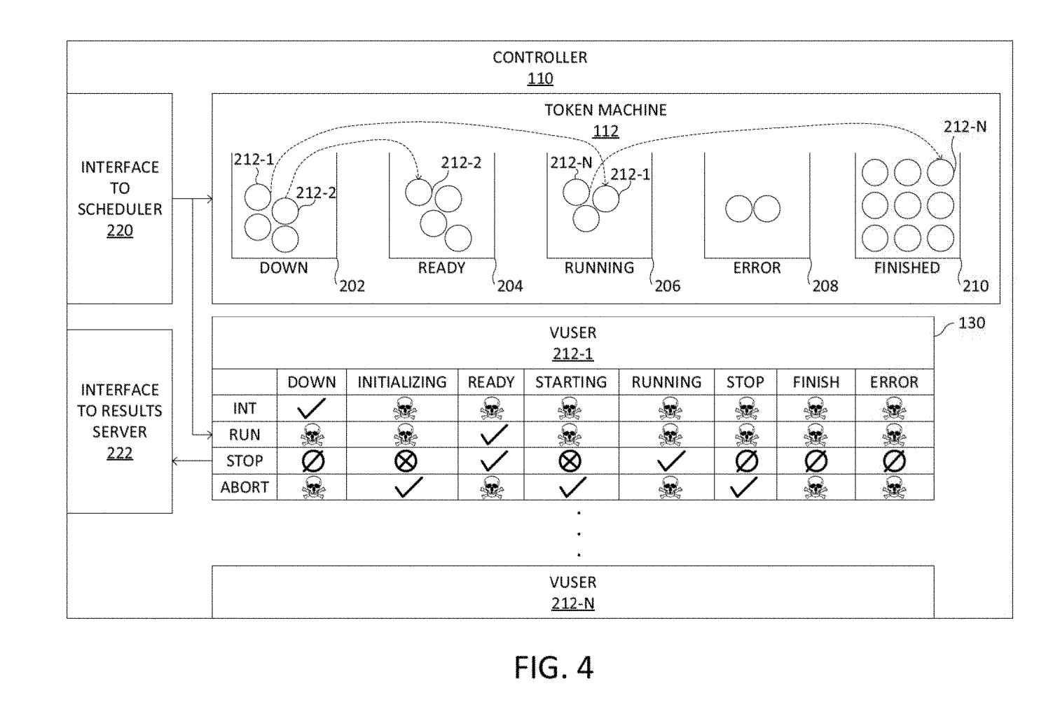

FIG. 4 illustrates a more detailed block diagram of the controller. In one example, as the tokens 212 are moved in accordance with the schedule, an observation of the movement and transitions for each one of the tokens 212 may be recorded for each virtual user represented by tokens 212-1 to 212-n in the table 130 in the virtual user module 114. For example, the virtual user module 114 may create a table 130 that may be used to track each one of the tokens 212, a current state of each one of the tokens 212 and an observation associated with each one of the tokens 212 during the schedule of transitions (e.g., initialize, run, stop, abort, and the like).

In one example, the table may be a Cartesian product that charts what operation each token 212 should perform at a particular state. For example, each token 212 at a state 202-210 may be able to perform a particular operation (e.g., initialize, run, stop, abort, and the like) and the Cartesian product tracks whether the token 212 is able to perform the operation in the particular state (e.g., successful (e.g., a check mark), did not complete (e.g., an “x”), failed (e.g., skull), was not applicable (e.g., a slash through a circle), and the like).

In one example, the controller 110 may also include an interface 222 to a results server (e.g., the results server 108) to transmit the observations of each virtual user 212-1 to 212-N collected in the virtual user module 114. For example, the table 130 or the Cartesian products may be transmitted to the results server and stored in the DB 120 over the interface 222.

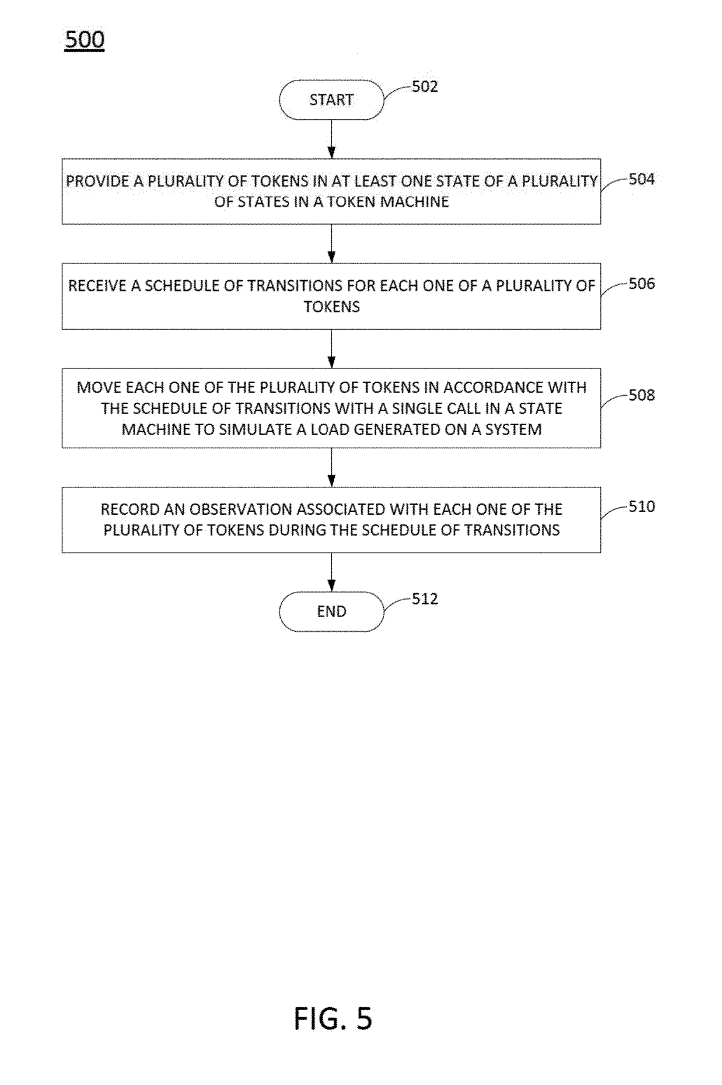

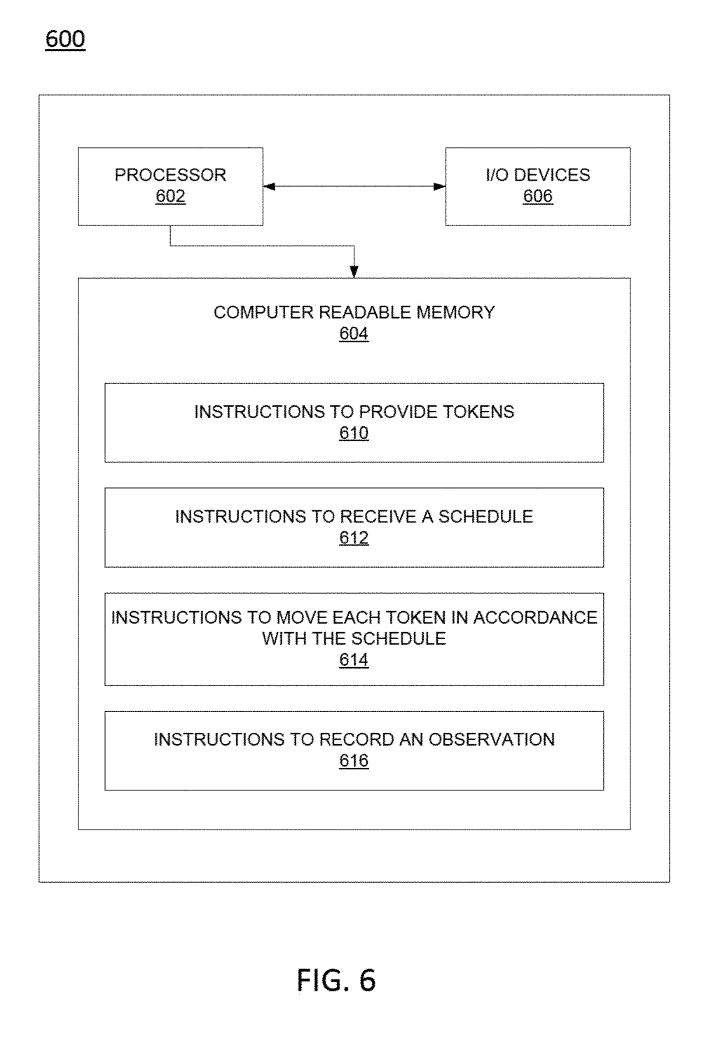

FIG. 5 illustrates an example flowchart of a method 500 for simulating a load generated on a system using a token machine. In one example, the method 500 may be performed by the controller 110 or the computer 600 illustrated in FIG. 6 and described below.

At block 502 the method 500 begins. At block 504, the method 500 provides a plurality of tokens in at least one state of a plurality of states in a token machine. For example, a system may be tested against a simulated load generated by a plurality of virtual users. In one example, the system may be a business logic (e.g., a website). A company may want to test how much traffic the company's new website can handle and see how the website may respond for each user. The company may estimate that 100,000 customers may attempt to access the new website when the website is launched.

Accordingly, 100,000 tokens may be provided in a token machine. Each one of the 100,000 tokens may represent a virtual user that will access the company's new website. The new website may be represented by a state machine. For example, a schedule lifecycle of the new website may include actions such as “log-in,” “browse,” “purchase,” and “log-out.” The states of the state machine (e.g., initialize, run, stop, and the like) may be bound to the actions of the new website. The scheduler and load-generator may define states and steps of the state machine to support the schedule lifecycle of the new website. Various movements of each token within the state machine may be an abstraction of the actions of the new website as defined by a script by the MDRV.

In one example, each one of the 100,000 tokens may be initialized to start at one of the states of the token machine. For example, some tokens may be placed in a “initialize” state, some tokens may be placed in a “start” state, and so forth.

At block 506, the method 500 receives a schedule of transitions for each one of a plurality of tokens. In one example, the schedule of transitions includes different transitions for different ones of the plurality of tokens. For example, the transitions of each one of the 100,000 virtual users may be programmed in a script using a single schedule of transitions. The schedule of transitions may define how each one of the 100,000 tokens is to move from state to state within the states of the token machine.

Said another way, the token machine allows the simulation of 100,000 customers on a company's new website via the user of tokens and a single state machine. In contrast, previous methods would require a user to simulate the 100,000 customers on 100,000 different replications of the same state machine. Each state of the 100,000 different state machines would have to be monitored for which states are active or inactive.

In contrast, the present disclosure has provided a unique structure via the token machine, the states of a single state machine and a plurality of tokens that each represents a different virtual user. The token machine has no active or inactive states. Rather, the “active” and “inactive” states in the token machine are tracked based on which state a token is currently located.

At block 508, the method 500 moves each one of the plurality of tokens between the plurality of states in accordance with the schedule of transitions with a single call to simulate a load generated on a system. In one example, the plurality of states may represent states of a state machine that is an abstraction of the system.

In other words, rather than requiring 100,000 different commands to move a state of each virtual user in the 100,000 state machines used in current methods, the present disclosure allows all 100,000 virtual users to move to a new state simultaneously with a single call (e.g., a programming call or execution of a programming code) in accordance with the schedule of transitions.

Said another way, all of the desired movements and transitions of each virtual user may be programmed into a single schedule. The controller of the token machine may then execute the schedule by moving each token representing each virtual user in accordance with the desired movements and transitions as programmed into the single schedule. Thus, regardless of whether the system tests 1 billion users or 100 users, the token machine may simulate the generated load using a single call in accordance with a schedule generated by a scheduler.

At block 510, the method 500 records an observation associated with each one of the plurality of tokens during the schedule of transitions. In one example, a table may be used to track observations of a behavior of the token in a particular state, such as whether a transition of a token was a success, whether the transition of the token was a failure, whether a token transitioned to a correct state in accordance with the schedule of transitions, and the like.

In one example, the table may include each state and transition of a state machine along a y-axis and result (e.g., initialize, run, stop or abort) of each state or transition along an x-axis. The table may be created for each virtual user associated with each token.

One advantage of the present disclosure is that the controller may automatically aggregate the observations (e.g., how many virtual users are in each state, what errors were encountered by virtual users in the different states, and the like) of all virtual users represented by the tokens. For example, in previous methods, a user observed each transition of each state machine one at a time. As a result, it would have been difficult for the user to detect any patterns at a particular state until all 100,000 iterations of the state machine are executed.

In contrast, by providing an ability to simulate all 100,000 virtual users simultaneously on a single state machine using the tokens, all of the observations may be aggregated by the controller. As a result, a user may immediately see that a particular state had 20,000 failures or errors and be notified that the state should be corrected or modified. In other words, the present disclosure not only provides a more efficient system and architecture for simulating a load generated on a system, but also provides more computational efficiency by aggregating all of the observations of each one of the tokens that are simultaneously moved in accordance with the schedule.

The recorded observations may be sent to a results server and stored in a database for further analysis or processing. For example, the recorded observations may be used to debug the system. For example, observations related to which states of the state machine were overloaded, which states of the state machine are not functioning properly, if new states or transitions are required, and the like, may correspond to particular actions of the system not functioning properly or being overloaded and helping to determine how the system should be debugged. Notably, all of these observations may be accomplished via a single state machine of the token machine using a plurality of tokens representing each virtual user using a single call. At block 512, the method 500 ends.

It should be noted that although not explicitly specified, any of the blocks, functions, or operations of the example method 500 described above may include a storing, displaying, and/or outputting block as required for a particular application. In other words, any data, records, fields, and/or intermediate results discussed in the methods can be stored, displayed, and/or outputted to another device as required for a particular application. Furthermore, blocks, functions, or operations in FIG. 5 that recites a determining operation, or involve a decision, do not necessarily require that both branches of the determining operation be practiced.

FIG. 6 depicts an example high-level block diagram of a computer that can be transformed to into a machine that is dedicated to perform the functions described herein. As depicted in FIG. 6, the computer 600 comprises a hardware processor element 602, e.g., a central processing unit (CPU), a processor, a microprocessor, or a multi-core processor; a non-transitory computer readable memory or medium, machine readable memory or storage 604, e.g., a random access memory (RAM); and various input/output user interface devices 606 to receive input from a user and present information to the user in human perceptible form, e.g., storage devices, including but not limited to, a tape drive, a floppy drive, a hard disk drive or a compact disk drive, a receiver, a transmitter, a speaker, a display, a speech synthesizer, an output port, an input port and a user input device, such as a keyboard, a keypad, a mouse, a microphone, and the like.

In one example, the non-transitory computer readable memory 604 may include a plurality of instructions 610, 612, 614 and 616. In one example, the instructions 610 may be instructions to provide tokens. In one example, the instructions 612 may be instructions to receive a schedule. In one example, the instructions 614 may be instructions to move each token in accordance with the schedule. In one example, the instructions 616 may be instructions to record an observation.

Although one processor element is shown, it should be noted that the computer may employ a plurality of processor elements. Furthermore, although one computer is shown in the figure, if the method(s) as discussed above is implemented in a distributed or parallel manner for a particular illustrative example, i.e., the blocks of the above method(s) or the entire method(s) are implemented across multiple or parallel computers, then the computer of this figure is intended to represent each of those multiple computers. Furthermore, hardware processors can be utilized in supporting a virtualized or shared computing environment. The virtualized computing environment may support virtual machines representing computers, servers, or other computing devices. In such virtualized virtual machines, hardware components such as hardware processors and computer-readable storage devices may be virtualized or logically represented.

It should be noted that the present disclosure can be implemented by machine readable instructions and/or in a combination of machine readable instructions and hardware, e.g., using application specific integrated circuits (ASIC), a programmable logic array (PLA), including a field-programmable gate array (FPGA), or a state machine deployed on a hardware device, a computer or any other hardware equivalents, e.g., computer readable instructions pertaining to the method(s) discussed above can be used to configure a hardware processor to perform the blocks, functions and/or operations of the above disclosed methods. In one example, instructions 610, 612, 614 and 616 can be loaded into memory 604 and executed by hardware processor element 602 to implement the blocks, functions or operations as discussed above in connection with the example method 500. Furthermore, the instructions 410, 612, 614 and 616 may be modified to implement the blocks, functions or operations as discussed above in connection with the example method 300. Furthermore, when a hardware processor executes instructions to perform “operations,” this could include the hardware processor performing the operations directly and/or facilitating, directing, or cooperating with another hardware device or component, e.g., a co-processor and the like, to perform the operations.

The processor executing the machine readable instructions relating to the above described method(s) can be perceived as a programmed processor or a specialized processor. As such, the instructions 610, 612, 614 and 616, including associated data structures, of the present disclosure can be stored on a tangible or physical (e.g., non-transitory) computer-readable storage device or medium, e.g., volatile memory, non-volatile memory, ROM memory, RAM memory, magnetic or optical drive, device or diskette and the like. More specifically, the computer-readable storage device may comprise any physical devices that provide the ability to store information such as data and/or instructions to be accessed by a processor or a computing device such as a computer or an application server.

It will be appreciated that variants of the above-disclosed and other features and functions, or alternatives thereof, may be combined into many other different systems or applications. Various presently unforeseen or unanticipated alternatives, modifications, or variations, therein may be subsequently made which are also intended to be encompassed by the following claims.

1. An apparatus, comprising:
a plurality of tokens, wherein the plurality of tokens are controlled in accordance with a schedule of transitions with a single call;
a plurality of states, wherein each one of the plurality of states represents a state of a state machine that is an abstraction of a business logic, wherein each one of the plurality of tokens is located at one of the plurality of states; and
an interface to a scheduler for receiving the schedule of transitions for moving the plurality of tokens between two states of the plurality of states, wherein a movement of the plurality of tokens in the state machine simulates a load generated on the business logic.

2. The apparatus of claim 1, further comprising:
a virtual user module for creating a table that tracks each one of the plurality of tokens, a current state of the each one of the plurality of tokens and an observation associated with the each one of plurality of tokens during the schedule of transitions.

3. The apparatus of claim 2, further comprising:
an interface to a results server for storing the table at a completion of the schedule of transitions.

4. The apparatus of claim 1, wherein the schedule of transitions includes different transitions for different ones of the plurality of tokens.

5. The apparatus of claim 1, wherein each one of the plurality of tokens represents a virtual user.

6. The apparatus of claim 1, wherein a number of the plurality of tokens is a function of a desired number of virtual users to simulate a generated load on the business logic.

7. The apparatus of claim 1, wherein the business logic comprises a website.

8. A method, comprising:
providing, by a processor, a plurality of tokens in at least one state of a plurality of states in a token machine;
receiving, by the processor, a schedule of transitions for each one of the plurality of tokens;
moving, by the processor, each one of the plurality of tokens between the plurality of states in accordance with the schedule of transitions with a single call to simulate a load generated on a system; and
recording, by the processor, an observation associated with each one of the plurality of tokens during the schedule of transitions.

9. The method of claim 8, wherein the schedule of transitions includes different transitions for different ones of the plurality of tokens.

10. The method of claim 8, wherein the plurality of states represents states of a state machine associated with the system.

11. The method of claim 10, wherein a number of the plurality of tokens is a function of a desired number of virtual users to simulate the load generated on the system.

12. The method of claim 11, wherein the system comprises a website.

13. The method of claim 8, wherein the observation comprises at least one of: whether a transition of a token was a success, whether the transition of the token was a failure, or whether a token transitioned to a correct state in accordance with the schedule of transitions.

14. An apparatus, comprising:
an integrations module comprising a scheduler; and
a controller in communication with the integrations module for receiving a schedule of transitions from the scheduler and moving each one of a plurality of tokens within a state machine in accordance with the schedule of transitions with a single call to simulate a load generated on a system, the controller comprising:
a token machine comprising the plurality of tokens, wherein the each one of the plurality of tokens is in one of a plurality of states of the state machine of the token machine; and
a virtual user module having a table that tracks each one of the plurality of tokens, a current state of the each one of the plurality of tokens, and an observation associated with each one of the plurality of tokens during the schedule of transitions.

15. The apparatus of claim 14, wherein the schedule of transitions includes different transitions for different ones of the plurality of tokens.
